(19) United States
(12) Patent Application Publication
(10) Pub. No.: US 2026/0366553 A1
(43) Pub. Date: Nov. 19, 2026

(54) NOVEL TELESCOPIC ROD

(71) Applicant: Hangzhou Yarun Houseware Co., Ltd., Hangzhou City (CN)

(72) Inventor: Zengjie Yu, Hangzhou City (CN)

(21) Appl. No.: 19/735,586

(22) Filed: Jul. 9, 2026

(51) Int. Cl. F16B 7/10

(52) U.S. Cl. CPC F16B 7/105

(57) ABSTRACT

A novel telescopic rod includes an inner tube and an outer tube, with a locking mechanism provided between the inner tube and the outer tube. The locking mechanism includes a base with a cavity inside. The cavity contains a trigger connected to a locking pin. The base is provided with a through hole. The locking pin can be driven by the trigger to extend into or retract from the through hole. The inner tube is provided with a radial hole. The outer tube is provided on a peripheral wall with a plurality of detent holes arranged in a straight line.

### TECHNICAL FIELD

The present disclosure relates to the technical field of telescopic rods, and in particular to a novel telescopic rod.

### BACKGROUND

Manual telescopic rods are used in extensive applications, such as window curtain rods and door curtain rods. A telescopic rod is composed of two rod-shaped components, one of which is nested in and slips relative to the other. A locking mechanism is provided between the two rod-shaped components, and is configured to lock the two rod-shaped components after the telescopic rod is opened or closed, thereby achieving the telescoping feature of the telescopic rod. The conventional locking structures for telescopic rods on the market are typically complex, resulting in not only high manufacturing costs, but also a heavy weight and insufficient portability.

### SUMMARY

The purpose of the present disclosure is to provide a novel telescopic rod designed to address the shortcomings in the prior art.

The present disclosure relates to a novel telescopic rod, which includes an inner tube and an outer tube coaxially fitted over the inner tube, with a locking mechanism provided between the inner tube and the outer tube; the locking mechanism includes a base connected to an end of the inner tube; the base has cavities inside, with a trigger provided in one of the cavities; the trigger is connected to a locking pin; the base is provided on a surface with a through hole connected to one of the cavities; the locking pin can be driven by the trigger to extend into or retract from the through hole; the inner tube is provided with a radial hole that is coaxial with the through hole and allows the locking pin to pass through; and the outer tube is provided on a peripheral wall with a plurality of detent holes arranged in a straight line along an axial direction; and

when the locking pin is in an extended state, the locking pin passes through the radial hole and then extends into one of the detent holes to lock the outer tube and inner tube; and when the locking pin is in a retracted state, the outer tube and inner tube are unlocked from each other, then the outer tube and inner tube can slip axially relative to each other.

Preferably, a pull cord is connected to the trigger; the pull cord passes through the base and then extends axially along the inner tube to serve as a force-application end; and when a force is applied to the force-application end, the trigger drives the locking pin to extend or retract.

For further optimization, the trigger includes a first slider, a first elastic member, and a pulley; a first sliding slot extending radially along the inner tube is provided on an inner wall of the cavities; the first slider is slidably connected to the first sliding slot; the locking pin is arranged at a radial end of the first slider, and moves with the first slider; the first elastic member is arranged between the other radial end of the first slider and the cavities; the pulley is rotatably mounted in one of the cavities; the pulley and the locking pin are located at two ends of the first elastic member respectively; a pull cord is fixedly attached to the first slider; one end of the pull cord is connected to an end of the first slider that abuts against the first elastic member; and the other end of the pull cord goes around the pulley and then extends axially along the inner tube to serve as the force-application end; and

when a force is applied to the force-application end of the pull cord to pull the pull cord, it pulls the first slider to move along the pulley, so the first slider compresses the first elastic member and slides, thereby causing the locking pin to retract; and when the driving force at the force-application end is removed, the first slider slides in an opposite direction under a restoring force of the first elastic member, thereby driving the locking pin to extend.

For further optimization, the trigger includes a second slider, a second elastic member, an L-shaped swing arm, and a rotary shaft; a second sliding slot is provided on the inner wall of the cavities; the second slider is slidably connected to the second sliding slot; the locking pin is connected to the second slider and moves with the second slider; the second elastic member is arranged between the second slider and the inner wall of the cavities; one end of the L-shaped swing arm extends to the connection point between the locking pin and the second slider and is provided with a notch, so one end of the L-shaped swing arm is snap-fit to the locking pin by means of the notch; the other end of the L-shaped swing arm is connected to the pull cord; and the L-shaped swing arm is rotatably mounted in one of the cavities by means of the rotary shaft; and

a pulling force is applied to the pull cord to pull one end of the L-shaped swing arm, making the L-shaped swing arm rotate around the rotary shaft, the other end of the L-shaped swing arm presses down on the second slider as the L-shaped swing arm rotates, making the second slider overcome the elastic force of the second elastic member and move downward; and in this state, the locking pin retracts, and the outer tube and the inner tube are unlocked from each other.

Preferably, the base includes a first end and a second end; an outer diameter of the first end is smaller than an outer diameter of the second end; the inner tube is fitted over the first end; and the outer tube is fitted over the second end and the inner tube.

For further optimization, the first end is provided on an outer peripheral wall with grooves that are symmetrically arranged; a snap-fit block with an elastic deformation capability extends from an inner wall of each of the grooves; the inner tube is provided on a peripheral wall with snap-fit slots; and after the inner tube is fitted over the first end, the snap-fit blocks engage with the snap-fit slots for position limiting, thereby securing the first end to the inner tube.

For further optimization, the base consists of two equal half blocks that are split radially; each of the two blocks is provided inside with hollows, and the hollows of the two blocks form the cavities after the two blocks are joined together; each of the two blocks is provided at an edge with a semi-hole; and the semi-holes of the two blocks form a through hole after the two blocks are joined together.

For further optimization, one end of the first slider is provided with a mounting hole; a positioning post is arranged at the center of the mounting hole; the first elastic member is a spring; and one end of the first elastic member is in the mounting hole and is fitted over the positioning post.

The technical effects of the present disclosure are as follows. The outer tube is fitted over the inner tube; a locking mechanism is provided at the end of the inner tube inserted into the outer tube; the outer tube is provided with detent holes; the locking mechanism includes a base, on which a retractable locking pin is provided; the base is provided inside with a trigger for driving the locking pin to extend or retract; the trigger is connected to a pull cord; one end of the pull cord is connected to the trigger; the other end of the pull cord passes through the base, and extends axially along the inner tube to serve as a force-application end; and when a pulling force is applied to the pull cord to drive the trigger, the trigger drives the locking pin to extend or retract; and

in a initial state, the locking pin is in an extended state and is inserted into a detent hole, to lock the inner tube and outer tube together; when the pull cord is pulled, it drives the trigger, which in turn drives the locking pin to retract; after the locking pin disengages from the detent hole, the inner tube and outer tube are unlocked, and the inner tube and outer tube can slip relative to each other for length adjustment; and when a preset length is achieved, the locking pin can extend into a corresponding one of the detent holes to lock the tubes. Therefore, the present disclosure is not only simple in structure and easy to implement, but also offers excellent stability.

### BRIEF DESCRIPTION OF DRAWINGS

FIG. 1 is an exploded view of the overall structure of a novel telescopic rod according to the present disclosure.

FIG. 2 is a schematic diagram of the structure of a base according to the present disclosure.

FIG. 3 is a cross-sectional view of the structure of a trigger according to Embodiment 1 of the present disclosure.

FIG. 4 is an exploded view of the structure of a first slider and a first elastic member according to Embodiment 1 of the present disclosure.

FIG. 5 is a cross-sectional view of the structure of a trigger according to Embodiment 2 of the present disclosure.

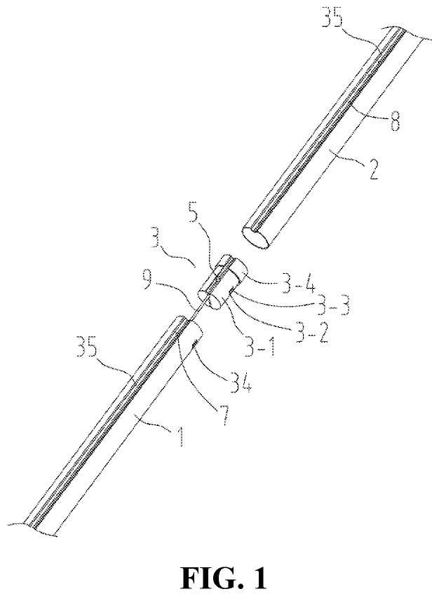

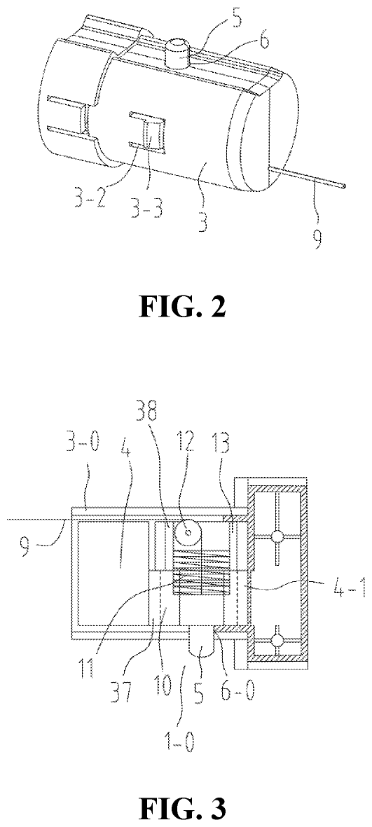

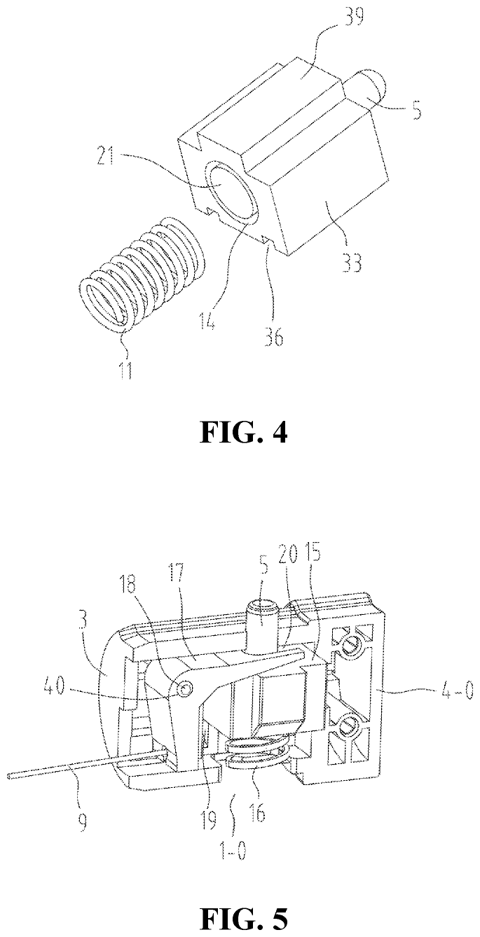

### REFERENCE NUMERALS

1. inner tube; 1-0. locking mechanism; 2. outer tube; 3. base; 3-0. block; 3-1. first end; 3-2. groove; 3-3. snap-fit block; 3-4. second end; 4. cavity; 4-0. hollow; 4-1. trigger; 5. locking pin; 6. through hole; 6-0. semi-hole; 7. radial hole; 8. detent hole; 9. pull cord; 10. first slider; 11. first elastic member; 12. pulley; 13. first sliding slot; 14. mounting hole; 15. second slider; 16. second elastic member; 17. L-shaped swing arm; 18. rotary shaft; 19. second sliding slot; 20. notch; 21. positioning post; 34. snap-fit slot; 35. limiting groove; 36. first guide slot; 37. first guide rail; 38. second guide rail; 39. second guide slot; 40. round hole.

### DETAILED DESCRIPTION OF THE EMBODIMENTS

### Embodiment 1

The present disclosure includes an inner tube 1 and an outer tube 2 coaxially fitted over the inner tube 1, with a locking mechanism 1-0 provided between the inner tube 1 and the outer tube 2. The locking mechanism 1-0 is configured to lock or unlock the inner tube 1 and the outer tube 2. When the locking mechanism 1-0 is in an unlocking state, the inner tube 1 and the outer tube 2 can slip relative to each other for length adjustment. When the locking mechanism 1-0 is in a locking state, the inner tube 1 and the outer tube 2 are locked.

The locking mechanism 1-0 includes a base 3 connected to an end of the inner tube 1. The base 3 has cavities 4 inside, with a trigger 4-1 provided in one of the cavities 4. The trigger 4-1 is connected to a locking pin 5. The base 3 is provided on a surface with a through hole 6 connected to one of the cavities 4. The locking pin 5 can be driven by the trigger 4-1 to extend into or retract from the through hole 6. The inner tube 1 is provided with a radial hole 7 that is coaxial with the through hole 6 and allows the locking pin 5 to pass through. The outer tube 2 is provided on a peripheral wall with a plurality of detent holes 8 arranged in a straight line along an axial direction. When the locking pin 5 is in an extended state, it passes through the radial hole 7 and then extends into one of the detent holes 8 to lock the outer tube 2 and inner tube 1. When the locking pin 5 is in a retracted state, the outer tube 2 and inner tube 1 are unlocked from each other, and then the outer tube 2 and inner tube 1 can slip axially relative to each other.

A pull cord 9 is connected to trigger the 4-1. The pull cord 9 passes through the base 3 and then extends axially along the inner tube 1 to serve as a force-application end. When a force is applied to the force-application end, that is, a pulling force is applied to the pull cord 9, the trigger 4-1 drives the locking pin 5 to extend or retract.

In this embodiment, the trigger 4-1 includes a first slider 10, a first elastic member 11, and a pulley 12. A first sliding slot 13 extending radially along the inner tube 1 is provided on an inner wall of the cavities 4. The first slider 10 is slidably connected to the first sliding slot 13, that is, the first slider 10 slides back and forth radially along the base 3. The locking pin 5 is arranged at a radial end of the first slider 10. In this embodiment, the locking pin 5 and the first slider 10 are fixed to each other, so the locking pin 5 moves with the first slider 10. The first elastic member 11 is arranged between the other radial end of the first slider 10 and the cavities 4. The pulley 12 is rotatably mounted in one of the cavities 4. The pulley 12 and the locking pin 5 are located at two ends of the first elastic member 11, respectively.

A pull cord 9 is fixed on the first slider 10. In this embodiment, the pull cord 9 is a steel wire, with one end connected to an end of the first slider 10 facing the first elastic member 11. The other end of the pull cord 9 goes around the pulley 12 and then extends axially along the inside of the inner tube 1 to the outside, serving as the force-application end.

When a force is applied to the force-application end to pull the pull cord 9, as the pull cord 9 is in a taut state, only a slight pulling force is required. Then the pull cord 9 pulls the first slider 10 to move along the pulley 12, and the first slider 10 overcomes the elastic force of the first elastic member 11 to slide. In this embodiment, the first elastic member 11 is a spring. When the first slider 10 is pulled by the pull cord 9, it compresses the first elastic member 11, and the first slider 10 moves to make the locking pin 5 retract.

It should be noted that the force-application end of the pull cord 9 may extend axially all the way to the other end of the inner tube 1, or extend to one side of the inner tube 1. A manual trigger switch may be provided on that side of the inner tube 1, and the pull cord 9 is connected to the manual trigger switch. Then, the manual trigger switch can be pressed to pull the pull cord 9. The manual trigger switch is a common transmission mechanism, which will not be described here.

When a force is applied to the force-application end of the pull cord 9, the pull cord 9 pulls the first slider 10 to move along the pulley 12. The pulley 12 is designed to change the direction of the pull cord 9 and make pulling easier. Then, the first slider 10 compresses the first elastic member 11 and slides, thereby causing the locking pin 5 to retract. When the driving force at the force-application end is removed, the first slider 10 slides in an opposite direction under a restoring force of the first elastic member 11, thereby driving the locking pin 5 to extend.

In a normal state, the first slider 10 is at one side under the elastic force of the first elastic member 11, that is, the locking pin 5 is in an extended state; and the inner tube 1 and outer tube 2 are in a locked state. For length adjustment, it is only necessary to pull the pull cord 9.

Further, one end of the first slider 10 is provided with a mounting hole 14. A positioning post 21 is arranged at the center of the mounting hole 14. One end of the first elastic member 11 is in the mounting hole 14 and is fitted over the positioning post 21, so the first elastic member 11 can be securely mounted in the mounting hole 14 to improve the stability of the first elastic member 11 during extension and retraction.

Further, a first guide slot 36 is provided on the surface at one side of the first slider 10, and a first guide rail 37 slidably engaging with the first guide slot 36 is provided on the inner wall of the cavities 4. A second guide rail 38 is provided on the surface of the other side of the first slider 10, and a second guide slot 39 slidably engaging with the second guide rail 38 is provided on the inner wall of the cavities 4, thereby achieving a sliding connection between both sides of the first slider 10 and the interior of the cavities 4. This ensures that the first slider 10 can slide more stably.

### Embodiment 2

In this embodiment, the trigger 4-1 includes a second slider 15, a second elastic member 16, an L-shaped swing arm 17, and a rotary shaft 18. A second sliding slot 19 is provided on the inner wall of the cavities 4. The second slider 15 is slidably connected to the second sliding slot 19. The sliding direction of the second slider 15 is the same as that of the first slider 10. The locking pin 5 is connected to the second slider 15 and moves with the second slider 15. The second elastic member 16 is arranged between the second slider 15 and the inner wall of the cavities 4. One end of the L-shaped swing arm 17 extends to the connection point between the locking pin 5 and the second slider 15 and is provided with a notch 20. Then, one end of the L-shaped swing arm 17 is between the second slider 15 and the inner wall of the cavities 4, making the notch 20 snap-fit to the locking pin 5. The other end of the L-shaped swing arm 17 is connected to the pull cord 9. A rotary shaft 18 is arranged in one of the cavities 4. A round hole 40 is provided in the L-shaped swing arm 17. The rotary shaft 18 passes through the round hole 40 in the L-shaped swing arm 17, so the L-shaped swing arm 17 can rotate about the rotary shaft 18. In this way, when a pulling force is applied to pull cord 9 to pull one end of the L-shaped swing arm 17, making the L-shaped swing arm 17 rotate around the rotary shaft 18; the end of the L-shaped swing arm 17 with the notch 20 performs press down on the second slider 15 as the L-shaped swing arm 17 rotates, making the second slider 15 overcome the elastic force of second elastic member 16 and moves downward. In this state, the locking pin 5 retracts, and the outer tube 2 and the inner tube 1 are unlocked from each other.

Further, the base 3 includes a first end 3-1 and a second end 3-4. The outer diameter of the first end 3-1 is smaller than the outer diameter of the second end 3-4. The inner tube 1 is fitted over the first end 3-1, and the outer tube 2 is fitted over the second end 3-4 and the inner tube 1.

Further, the first end 3-1 is provided on an outer peripheral wall with grooves 3-2 that are symmetrically arranged, and a snap-fit block 3-3 with an elastic deformation capability extends from an inner wall of each of the grooves 3-2. In this embodiment, the base 3 is made of plastic, so the snap-fit block 3-3 is also made of plastic, with one end integrally connected to the inner wall of the corresponding one of the grooves 3-2, and the other end as a free end, thereby forming the snap-fit block 3-3 with an elastic deformation capability. The inner tube 1 is provided on a peripheral wall with snap-fit slots 34. After the inner tube 1 is fitted over the first end 3-1, the snap-fit blocks 3-3 engage with the snap-fit slots 34 for position limiting, thereby forming a detachable fixed connection between the first end 3-1 and the inner tube 1. This design is not only structurally simple but also facilitates mounting and removal.

Further, the base consists of two radially split half blocks, that is, the cylindrical base 3 is split along its axial cross-section into two equal half blocks 3-0. Each of the two blocks 3-0 is provided with hollows 4-0, and the hollows 4-0 of the two blocks 3-0 form the cavities 4 after the two blocks 3-0 are joined together. It should be noted that the base 3 is internally partitioned into independent cavities 4, for positioning and mounting the components of the trigger 4-1. Each of the two blocks 3-0 is provided at an edge with a semi-hole 6-0, and the semi-holes 6-0 of the two blocks 3-0 form a through hole 6 after the two blocks 3-0 are joined together.

Therefore, the embodiments described above illustrate two structures of the trigger 4-1. It should be noted that the locking pin 5 is in the extended state under the action of the first elastic member 11 or the second elastic member 16, that is, the inner tube 1 and the outer tube 2 are in the locked state, which means that the inner tube 1 and the outer tube 2 are normally in the locked state. When a pulling force is applied to the pull cord 9, the pull cord 9 pulls the trigger 4-1, and the trigger 4-1 makes the locking pin 5 retract, so the locking pin 5 disengages from one of the detent holes 8. In this way, the inner tube 1 and the outer tube 2 are in the unlocked state, so the inner tube 1 and the outer tube 2 can slip relative to each other to adjust the length of the telescopic rod. During the process that the inner tube 1 and the outer tube 2 slip relative to each other, the pull cord 9 must remain pulling the trigger 4-1 till the outer tube 2 and the inner tube 1 arrive at preset positions. Then the pull cord 9 is released, and the locking pin 5 extends into the corresponding one of the detent holes 8 to lock the telescopic rod.

Both the first elastic member 11 and the second elastic member 16 are springs.

In addition, both the inner tube 1 and the outer tube 2 are round tubes. For both the inner tube 1 and the outer tube 2, a limiting groove 35 axially extending is provided on the side where the locking pin 5 is located. The radial hole 7 and the detent holes 8 are arranged in the corresponding limiting grooves 35, so the locking pin 5 is completely in the limiting grooves 35. In this way, the locking pin 5 will not interfere with the fitting between the inner tube 1 and the outer tube 2, while forming a radial position limit effect between the inner tube 1 and the outer tube 2. This method can prevent the inner tube 1 and the outer tube 2 from relative rotation.

The present disclosure is not limited to the preferred embodiments described above, and anyone may get other products in various forms under the inspiration of the present disclosure. However, whatever changes are made in the shape or structure, any technical solution that is the same or similar to the present disclosure will fall within the scope of protection of the present disclosure.

What is claimed is:

1. A novel telescopic rod, comprising an inner tube and an outer tube coaxially fitted over the inner tube, with a locking mechanism provided between the inner tube and the outer tube, wherein the locking mechanism comprises a base connected to an end of the inner tube; the base has cavities inside, with a trigger provided in one of the cavities; the trigger is connected to a locking pin; the base is provided on a surface with a through hole connected to one of the cavities; the trigger can drive the locking pin to extend into or retract from the through hole; the inner tube is provided with a radial hole that is coaxial with the through hole and allows the locking pin to pass through;
and the outer tube is provided on a peripheral wall with a plurality of detent holes arranged in a straight line along an axial direction; and
when the locking pin is in an extended state, the locking pin passes through the radial hole and then extends into one of the detent holes to lock the outer tube and inner tube; and when the locking pin is in a retracted state, the outer tube and inner tube are unlocked from each other, and then the outer tube and inner tube can slip axially relative to each other.

2. The novel telescopic rod according to claim 1, wherein a pull cord is connected to the trigger; the pull cord passes through the base and then extends axially along the inner tube to serve as a force-application end; and when a force is applied to the force-application end, the trigger drives the locking pin to extend or retract.

3. The novel telescopic rod according to claim 2, wherein the trigger comprises a first slider, a first elastic member, and a pulley; a first sliding slot extending radially along the inner tube is provided on an inner wall of the cavities; the first slider is slidably connected to the first sliding slot; the locking pin is arranged at a radial end of the first slider, and moves with the first slider; the first elastic member is arranged between the other radial end of the first slider and the cavities; the pulley is rotatably mounted in one of the cavities; the pulley and the locking pin are located at two ends of the first elastic member respectively; a pull cord is fixedly attached to the first slider; one end of the pull cord is connected to an end of the first slider that abuts against the first elastic member; and the other end of the pull cord goes around the pulley and then extends axially along the inner tube, serving as the force-application end; and
when a force is applied to the force-application end of the pull cord to pull the pull cord, the pull cord pulls the first slider to move along the pulley, so the first slider compresses the first elastic member and slides, thereby causing the locking pin to retract; and when the driving force at the force-application end is removed, the first slider slides in an opposite direction under a restoring force of the first elastic member, thereby driving the locking pin to extend.

4. The novel telescopic rod according to claim 2, wherein the trigger comprises a second slider, a second elastic member, an L-shaped swing arm, and a rotary shaft; a second sliding slot is provided on the inner wall of the cavities; the second slider is slidably connected to the second sliding slot; the locking pin is connected to the second slider and moves with the second slider; the second elastic member is arranged between the second slider and the inner wall of the cavities; one end of the L-shaped swing arm extends to the connection point between the locking pin and the second slider and is provided with a notch, so one end of the L-shaped swing arm is snap-fit to the locking pin by means of the notch; the other end of the L-shaped swing arm is connected to the pull cord; and the L-shaped swing arm is rotatably mounted in one of the cavities by means of the rotary shaft; and
a pulling force is applied to the pull cord to pull one end of the L-shaped swing arm, making the L-shaped swing arm rotate around the rotary shaft; the other end of the L-shaped swing arm presses down on the second slider as the L-shaped swing arm rotates, making the second slider overcome the elastic force of the second elastic member and move downward; and in this state, the locking pin retracts, and the outer tube and the inner tube are unlocked from each other.

5. The novel telescopic rod according to claim 1, wherein the base comprises a first end and a second end, wherein an outer diameter of the first end is smaller than an outer diameter of the second end, the inner tube is fitted over the first end, and the outer tube is fitted over the second end and the inner tube.

6. The novel telescopic rod according to claim 5, wherein the first end is provided on an outer peripheral wall with grooves that are symmetrically arranged; a snap-fit block with an elastic deformation capability extends from an inner wall of each of the grooves; the inner tube is provided on a peripheral wall with snap-fit slots; and after the inner tube is fitted over the first end, the snap-fit blocks engage with the snap-fit slots for position limiting, thereby securing the first end to the inner tube.

7. The novel telescopic rod according to claim 5, wherein the base consists of two equal half blocks that are split radially; each of the two blocks is provided inside with hollows, and the hollows of the two blocks form the cavities after the two blocks are joined together; and each of the two blocks is provided at an edge with a semi-hole, and the semi-holes of the two blocks form a through hole after the two blocks are joined together.

8. The novel telescopic rod according to claim 3, wherein one end of the first slider is provided with a mounting hole; a positioning post is arranged at the center of the mounting hole; the first elastic member is a spring; and one end of the first elastic member is in the mounting hole and is fitted over the positioning post.
